(19) United States
(12) Patent Application Publication
(10) Pub. No.: US 2007/0030842 A1
(43) Pub. Date: Feb. 8, 2007

(54) SYSTEM FOR THE ANALYSIS AND MONITORING OF IP COMMUNICATIONS

(76) Inventors: Walter Borden, Bethesda, MD (US); Naveen Agnihotri, New York, NY (US)

Correspondence Address: Dennis M. Carleton, Esquire;Buchanan Ingersoll PC, One Oxford Centre, 20th Floor, 301 Grant Street, Pittsburgh, PA, 15219, US

(21) Appl. No.: 11/458,259

(22) Filed: Jul. 18, 2006

Related U.S. Application Data
(60) Provisional application No. 60/700,102, filed on Jul. 18, 2005.

(51) Int. Cl. H04L 12/66

(52) U.S. Cl. 370/352; 370/250

(57) ABSTRACT

A system is claimed that deploys a multi-layer neural network for analyzing, categorizing and organizing conversations and video conferencing on Voice over Internet Protocol (VoIP), The parallel architecture of this implementation is an artificial neural network which allows it to process very large amounts of voice data very efficiently, both in dealing with large, continuous streams of information in real time as well as on voice data archives This invention uses its neural network to operate considerably faster than its linear counterparts as found ill current VoIP message and call management software.

### RELATED APPLICATIONS

This application claims the benefit of U.S. Provisional Patent Application 60/700,102, filed Jul. 18, 2005, entitled Neural Network for Voice Over Internet Protocol,

### FIELD OF THE INVENTION

This invention is related to the fields of IP telephony and artificial intelligence technology, and, in particular, to a system and method for performing pattern recognition on communications utilizing voice over IP (VoIP) to detect malicious behavior. Specifically, the present invention relates to using neutral networks to learn about, analyze and report of the content of digital voice and audio files on computers and as transmitted and stored the Internet,

### BACKGROUND OF THE INVENTION

Peer-2-Peer (P2P) communications refers to direct communications between similar processes running on different computers Such communications differ from traditional machine to machine communication applications, such as e-mail, in that P2P communications bypass servers and allow hosts to communicate directly with each other Instant messaging (IM) is a P2P application that allows people to interact in real-time by rapidly exchanging short messages, files and information, and, in some cases, allowing voice and/or video transfers, Likewise, internet relay chat (IRC) is another P2P application that allows users to meet in multi-user or private “chat rooms” to carry on real-time conversations.

The various P2P applications are very popular among children and teens and represent a fertile environment for their exploitation by on-line predators seeking to expose children to sexual materials or pornography, or to lure children into off-line meetings Likewise, the use of P2P applications by adults in the workplace represent a risk for employers because if legal liability issues and the danger the files shared using P2P service may contain potentially malicious or harmful viruses which may destroy or seriously hamper the ability of the business to function.

Current counter-measures to malicious behavior in instant messages and on-line chat rooms typically includes the use of filters which rely on static databases, blacklists, rules or signatures. While such systems can detect particular words or phrases, it is also useful to have information regarding the context of the communication, which can be determined using pattern recognition techniques, such as Natural Language Processing NLQ and NLP), Bayesian Filtering, Neural Networks and other statistical and analytical techniques. Such a system is disclosed in Published U.S. Patent Application 2004/0111479 A1 (Jun. 10, 2004) by the same inventors listed herein. That application is incorporated herein in its entirety.

Internet Protocol Telephony (IPT) enables enterprises to consolidate voice, fax, and other forms of information traditionally carried over the dedicated circuit-switched connections of the Public Switched Telephone Network (PSTN) with a single, converged communications infrastructure that can create operational efficiency and a foundation for a more flexible infrastructure. VoIP is any technology providing voice telephony services over Internet Protocol (IP), or packet-switched networks. IP is a connectionless, best-effort packet switching protocol. It provides packet routing, fragmentation and re-assembly through the data link layer or the network layer for the TCP/IP protocol suite widely used on Ethernet networks. The International Multimedia Teleconferencing Consortium Conferencing (IMTC) over IP has also defined Conferencing over IP (CoIP). The IMTC has endorsed the IP Telephony through the use of International Telecommunications Union (ITU) protocol standard H.323, a standard for sending voice (audio) and video using IP on the Internet and within intranets. H.323 is sponsored by the IMTC's Conferencing over IP Activity Group. VoIP uses “VoIP Devices” such as gateways that route voice packets over the Internet or PSTN, It uses protocols such as SGCP and its successor MGCP. Most VoIP hardware and software configurations are standardized on communications standard H.323 referenced above.

Many vendors provide VoIP solutions that provide a unified messaging solution which delivers e-mails, voice messages and fax transmissions to a single inbox. These systems may provide the capability enabling a user to listen to e-mail over the telephone, check voice messages from the Internet, and manage image files. These applications integrate popular email clients such as Microsoft's Outlook e-mail client, Such features also offer text-to-speech capability and allow the user to hear the text portion of e-mail messages over the telephone.

### SUMMARY OF THE INVENTION

The system and method of the present invention provides monitoring, detection reporting, and filtering of activity in the VoIP or CoIP environments with the goals being successful content analysis and filtering containment of unauthorized online activity and malicious behavior. A set of algorithms has been developed that analyze content and behavioral patterns in voice VoIP and CoIP exchanges, They are a combination of algorithmic approaches from the fields of data mining, artificial intelligence and machine learning. The present invention expands existing detection methods through the introduction of new algorithms in order to insure the detection of content and recognition of patterns. Its design allows it to detect current fraud techniques, unsolicited communications or important content, but of new and emerging patterns of threats and/or message senders.

The present invention utilizes a recurrent neural network model based on a modified non-negative boltsman machine that describes multi modal non-negative data. The neural network of the present invention is capable of analyzing, categorizing and organizing voice and video communications on internet protocol (IP) networks. The present invention will utilize neural network technologies to learn about the patterns of message delivery receipt in transmitting. It also analyzes the content of the messages as to whether they include images, video or text included within. The system and method alerts the user to the arrival status and disposition of important messages, filters messages based on the preferences of the user and/or network administrators, acts on specific incoming calls in manners such as forwarding them automatically and is configured to learn to detect fraudulent, malicious, unsolicited and unauthorized communications and/or network activity. These features and functionalities are achieved using neural network and associated machine learning in data mining techniques.

The present invention adds machine learning and neural network technology to VoIP at the endpoints such as: IP phones, video terminals, and other user devices that connect to IP communications systems. It also adds neural network algorithms and data structures to the user applications that run them, such as conferencing, unified messaging, customer contact, and Extensible Markup Language (XML)-enabled communications, as well as custom tools that will significantly extend the capabilities of IP communications system. These tools allow for search and discovery of content in voice files based on pre-specified preferences as well as personalized reporting about un-reviewed VoIP files.

Such reporting includes alerting a user to the content, sender or status of a file a prioritized basis as trained or otherwise specified by the user—a voice mail report issued will say “You have a call from your wife and 10 other new messages.” In addition, the present invention contains a reporting function that will assign rankings, (0-10, 1-10, 0-100, 1-100, etc.,) coded indications (red, orange, yellow, green, blue; black, grey, white, as well as other admixtures such as magenta, turquoise and any others displayable on a monitor for a computer or PDA), tones, such as the kind currently found on telephone systems and/or customizable ones (in an audio, image, or video format) in order to alert the user of voice mail about the status and disposition of the message or call. For example, the trained suite of algorithms may flag a voice mail from an unknown caller using the word “sell” in their message with 1 to correspond with the lowest possible level of importance, or they may upload an audio/video file to signify to them that a call is a of a pre-specified category or caller.

An artificial neural network is composed of an interconnected group of artificial neurons, each one of them modeled after the actual biological neurons in the brain. Neural networks are designed to capture some properties of biological networks by virtue of their similarity in structure and function. Whereas the individual processing elements (neurons) are simple, the network is capable of complex global behavior, determined by the properties of the connections between the neurons.

Neural networks find wide applications because of the property of learning. Given the right setup parameters, and a large training data set, a neural network can be taught to differentiate one kind of pattern from another. A neural network is an adaptive model that can learn from the data and generalize things learned. It extracts the numerical characteristics from the numerical data instead of memorizing all of it. Because of their ability to learn and differentiate patterns, neural networks find applications is a wide variety of fields, including vehicle control, game-playing, object recognition, medical diagnosis, financial applications, data mining, spam filtering, among many others.

One powerful feature of traditional neural networks (as described above) is that they require little or no a priori knowledge of the problem. But this is also a limitation because they don't allow any way for the scientist or the programmer to specify any previously known facts about the relationships of the inputs or the input to the output In that sense, they are data-rich and theory-poor. A neural network can build relationships from inputs to outputs but the precise behavior of the system is not understood.

Monitoring, detection, reporting, and filtering of activity in VoIP or IPT environments is achieved by the present invention by utilizing a novel neural network. Preliminary identification and categorization of desirable and non-desirable inputs is crucial to the implementation of a secure and all-encompassing filtering system to guarantee maximum content analysis and filtering. The following list is presented to outline the reader's understanding of content analysis and filtering requirements in both converging (legacy/IP) and next-generation (IP only) networks. These two network descriptions can be combined to form what commonly is referred to in the industry as Next Generation Network (NGN) technologies. These technologies share certain traits: 1) They are open and distributed by nature; 2) Lack inherent security mechanisms; 3) Run mission-critical applications; 4) Offer few “off-the-shelf expert solutions for their effective management and thus require integration and configuration specific to the site.

NGN behavioral analysis and content recognition/filtering requires new engineering and solutions, like that of the neural network of the present invention. Content on NGNs is thus hard to track and easy to mask and thus such networks are vulnerable to hackers. NGN security and content filtering/management mechanisms are difficult to maintain, as result of the following: 1) Inadequate password protocols; 2) Incorrect configuration of firewalls; 3) Low employee awareness of security risks; 4) Insufficient knowledge of NON environments and; 5) Enables unauthorized activity to be committed from multiple points in the network simultaneously.

As a result of such factors as IRC (Internet Relay Chat) channels that enable free transfer of sensitive information over open connections and make tools, scripts, and detailed hacking instructions and publicly available on the Internet and “Always-on” access technologies put domestic users at higher risk. As a result, content aware software applications for NGNs are critical to their success.

The present invention is thus an innovation in a non-obvious way in a growing public realm of NON or VoIP/IPT communications networks. This is borne of the fact that the number such services are rising and thus businesses are therefore shifting toward IP networks, service values are based on content, not connections, unlawful intrusion, resource abuse, and deliberate sabotage are easily committed, user identification, passwords, credit cards details, and codes are readily available and the potential for illegal gain is much higher than that offered by traditional network hacking.

The underlying neural network of the present invention can help to combat increasing rates of subscriber and internal fraud. By learning about behavior and identifying patterns it is a strong approach to sophisticated hacking that is no longer motivated by challenge or thrill. In addition, NGNs require new billing systems and they can and are being easily and unlawfully manipulated while new and highly complex methods of fraud are introduced daily and the scenarios are ever-changing. New hacking methods remain secret thus enabling recurrence on another network.

The neural network of the present invention meets the requirements for successful content analysis, and filtering containment of unauthorized activity on NGN's. As described above, security and content management mechanisms must be complemented by a central content and filtering system. The present invention works as a centralized behavioral and content analysis system by doing the following. It will help maintain the integrity of the and security infrastructure act against the adversary and not against the specific attempt. It will allow for user-friendly configuration. Its algorithms will function an intelligent means of data collection. By detecting and reporting about results on-line it will enables immediate counteraction before severe harm is done. Lastly its core neural network technology and will assimilate the now familiar patterns to prevent recurrence.

### BRIEF DESCRIPTION OF THE DRAWINGS

FIG. 1 shows a Next Generation Network

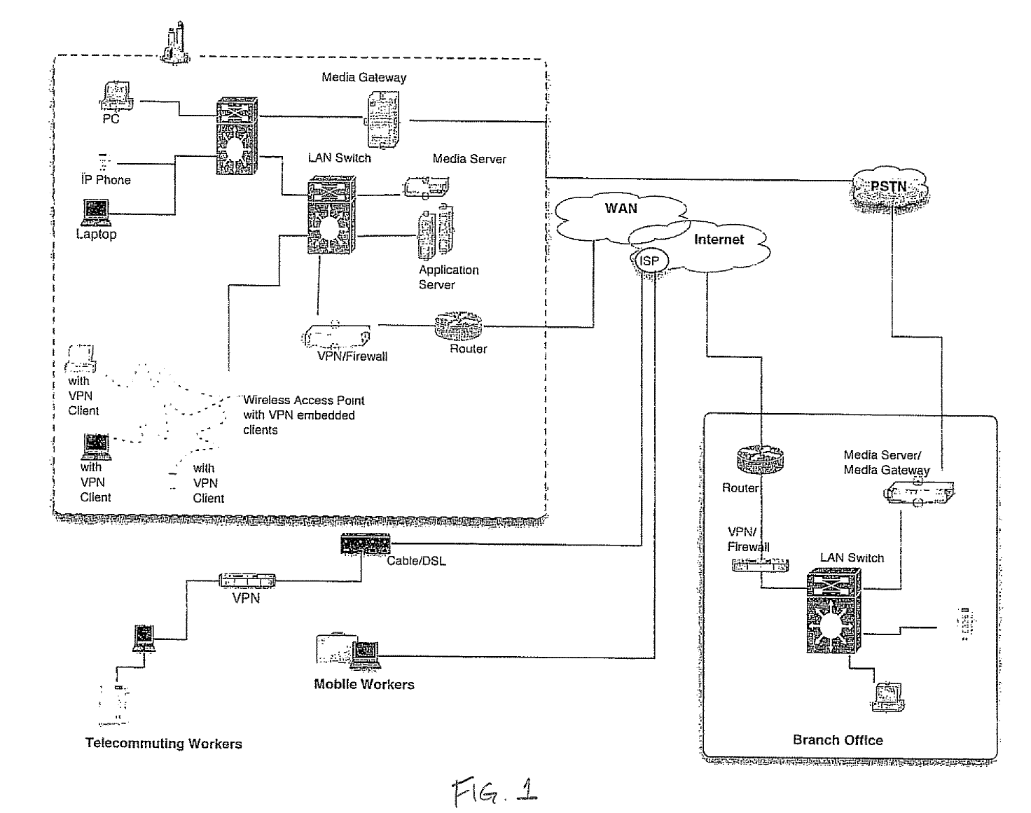

FIG. 2 shows a system level diagram having components of the present invention integrated therewith

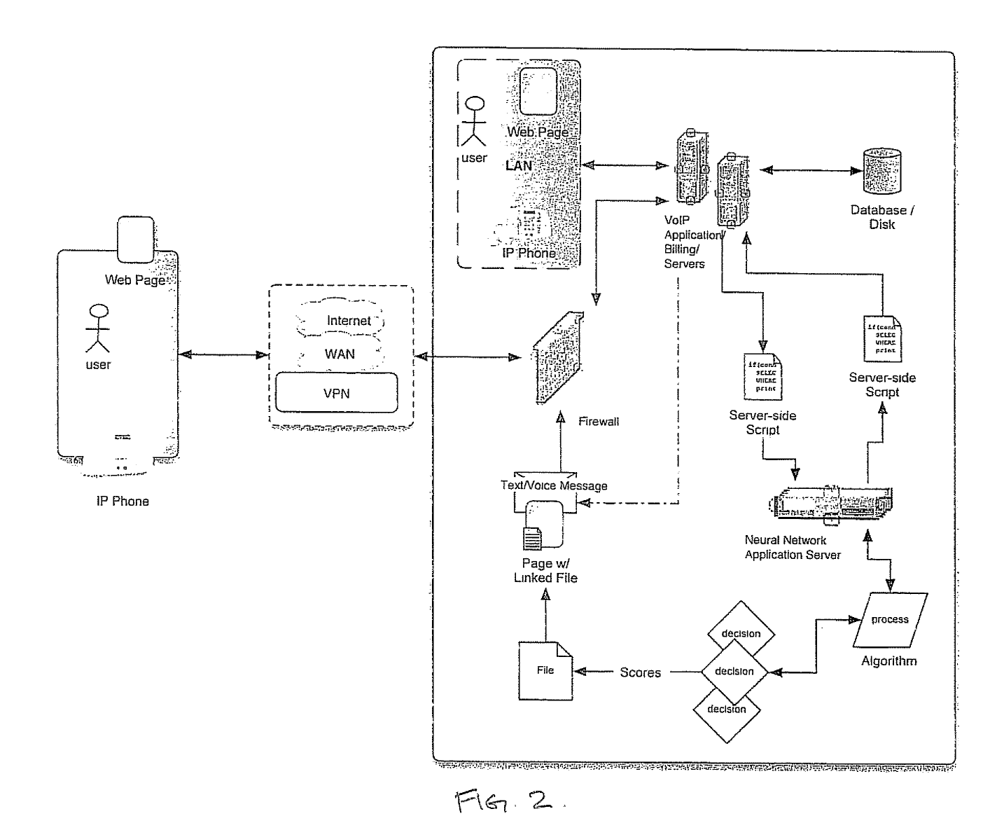

FIG. 3 is an architecture diagram showing IPT logical security,

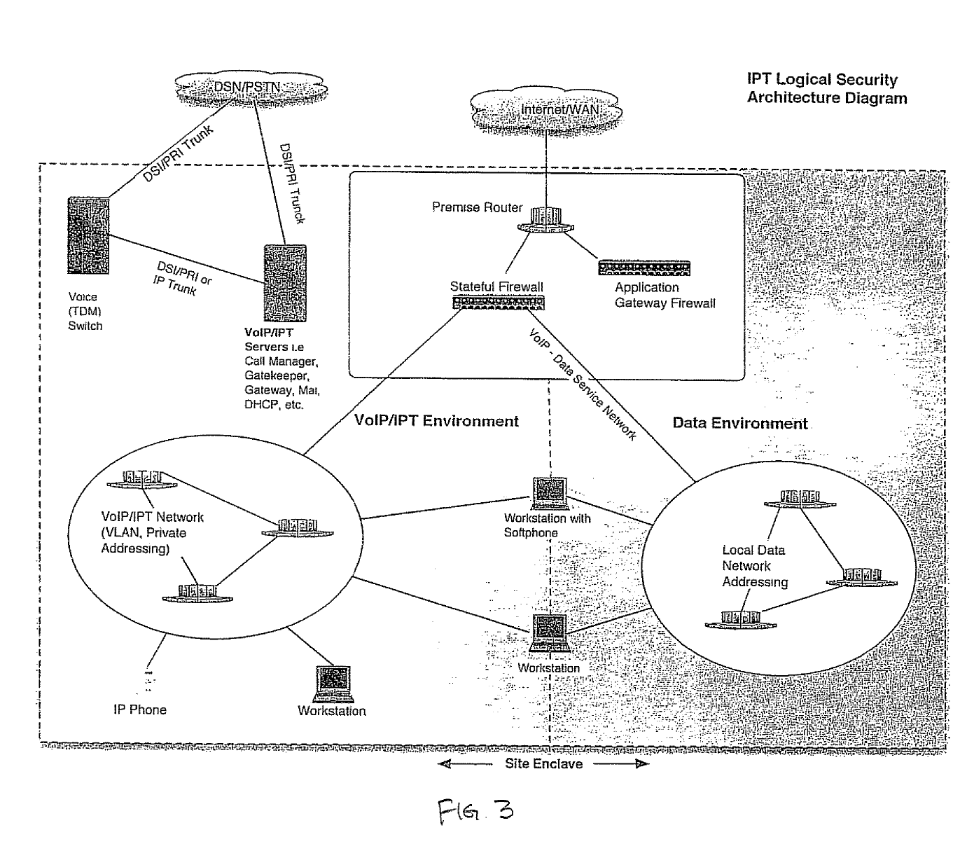

FIG. 4 is an example of a VoIP/IPT network configuration,

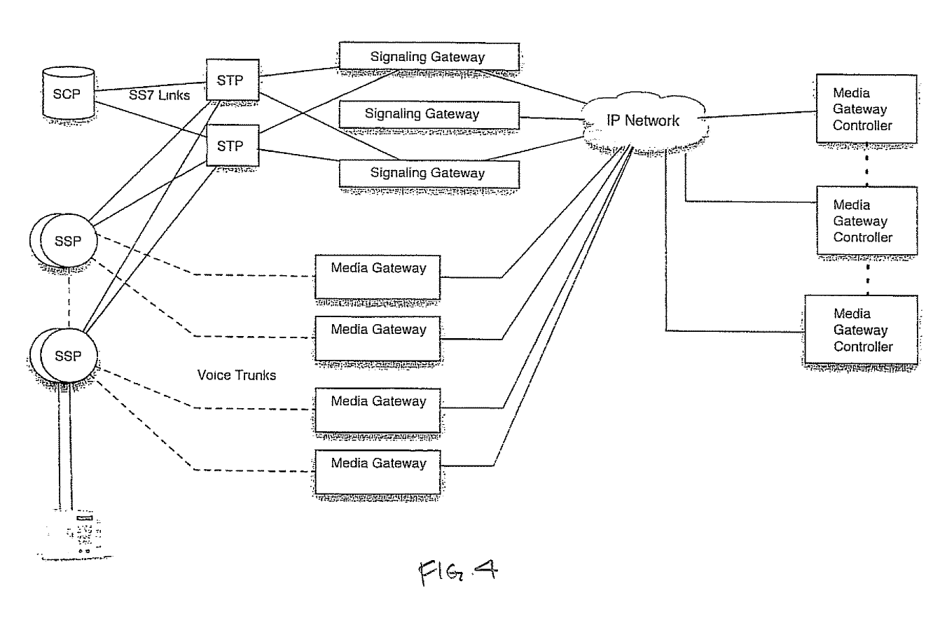

FIG. 5 is an upper level functional diagram of the present invention.

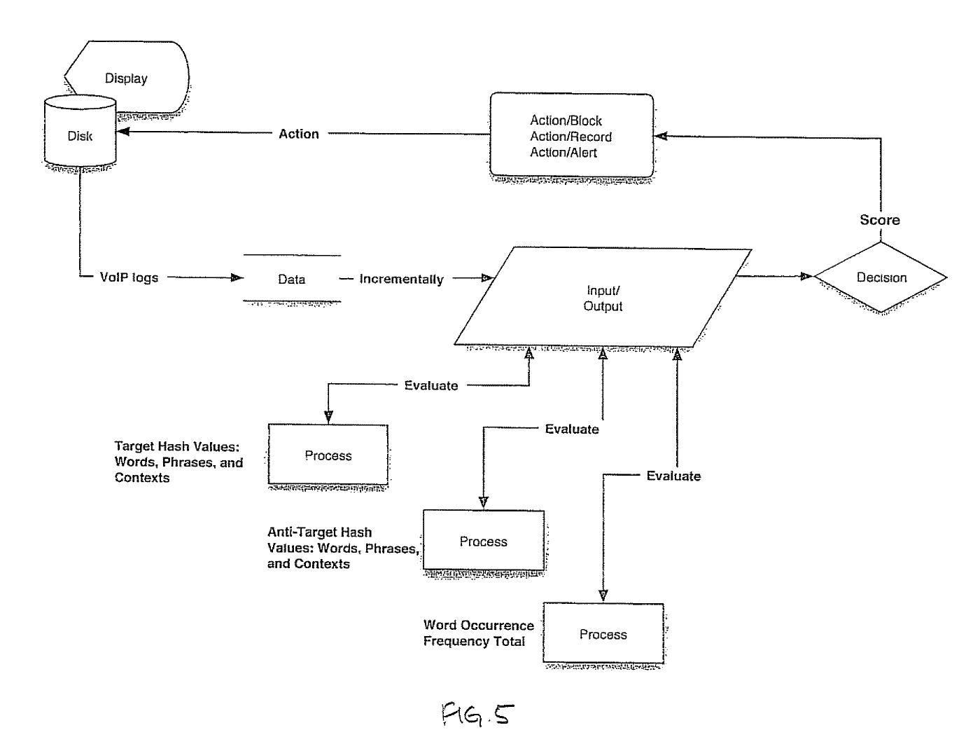

FIG. 6 is an example of an application of the present invention.

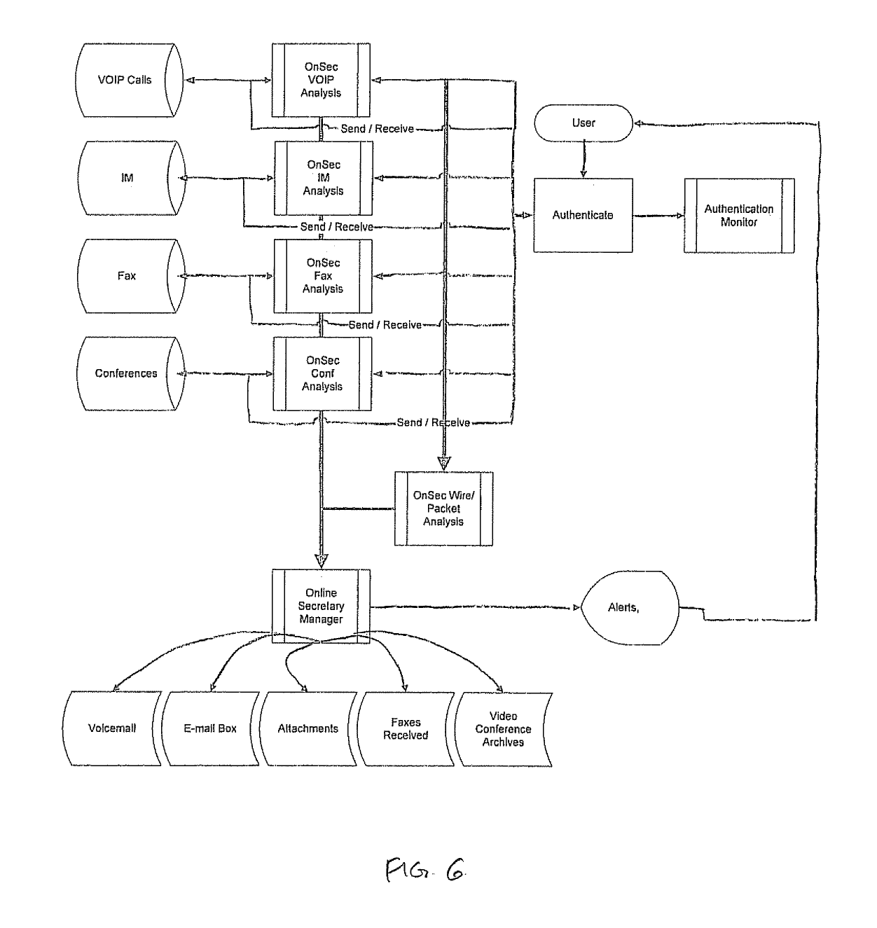

FIG. 7 is an upper level flow chart showing the processing of a new voicemail message.

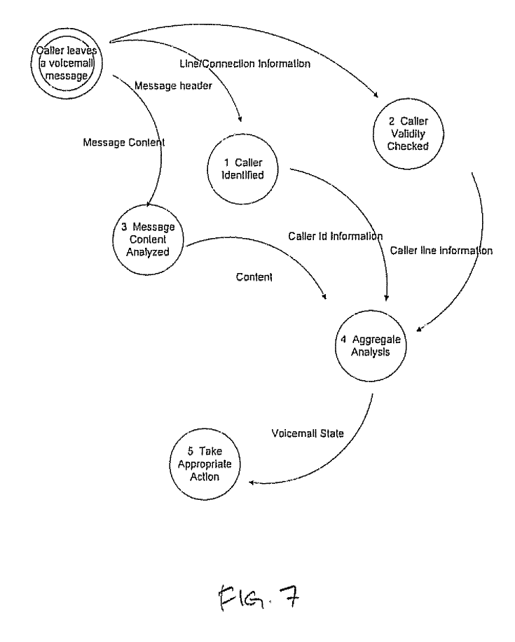

FIG. 8 is a flow chart of the caller identification portion of the upper level flow chart of FIG. 7.

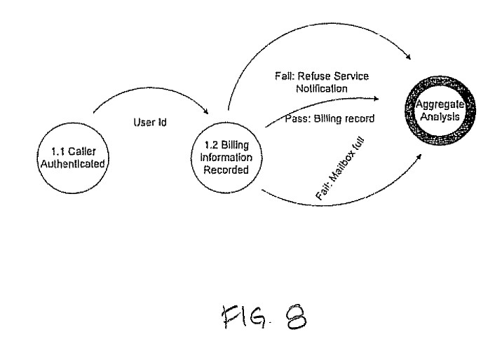

FIG. 9 is a flow chart of the caller authentication portion of the flow chart of FIG. 8.

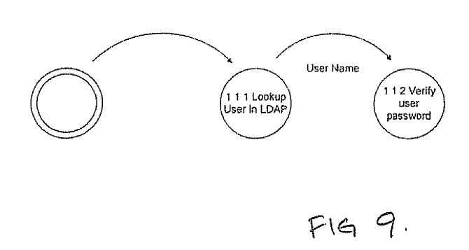

FIG. 10 is a flow chart of the caller validity checking portion of the upper level flow chart of FIG. 7.

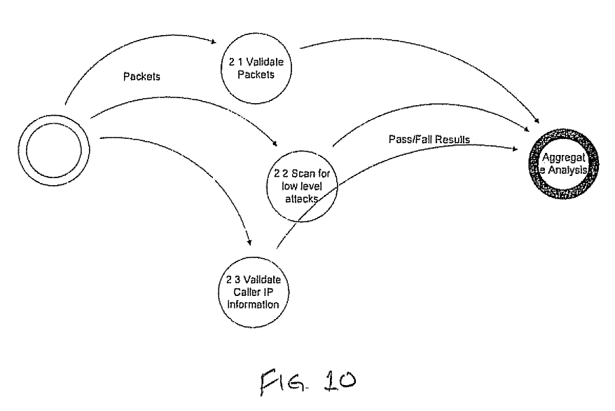

FIG. 11 is a flow chart of the message analysis portion of the upper level flow chart of FIG. 7.

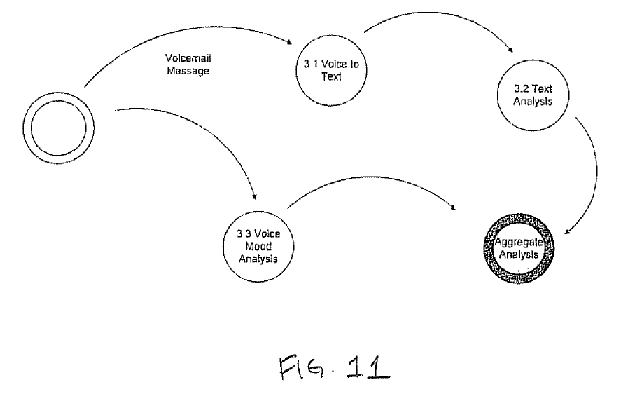

FIG. 12 is a flow chart of the aggregate analysis portion of the upper level flow chart of FIG. 7.

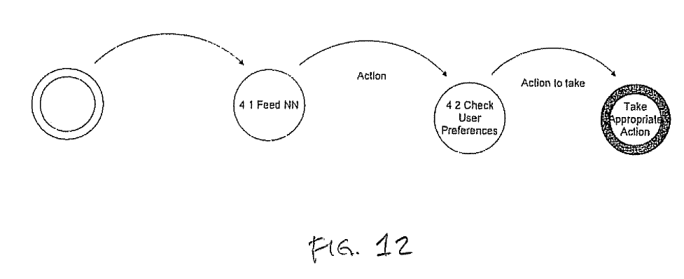

FIG. 13 is a flow chart of the action identification and execution portion of the upper level flow chart of FIG. 7.

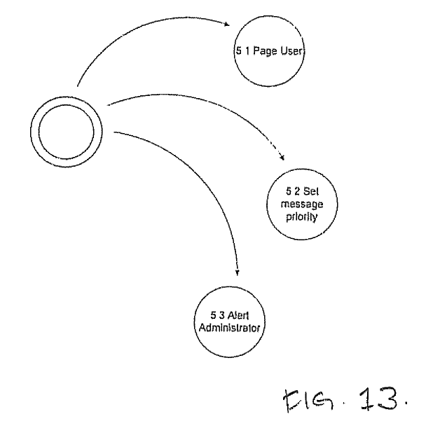

### DETAILED DESCRIPTION OF THE INVENTION

The preferred embodiment of the present invention is implemented as a software module which may be executed on a computer system or computer network in a conventional manner. Using well known techniques, the software of the preferred embodiment is stored on data storage medium and subsequently loaded into and executed within a computer system. Once initiated, the software of the preferred embodiment operates in the manner described.

The preferred embodiment of this invention involves a software module that is trained to find content of specific interest to the user. The training involves adding voice files to the system and instructing the system to learn about them. A second software module is used for the detection of target content and provides an interactive lookup tool for expressions, dependencies and characteristic in captured voice files. Before automatic generation of rules can he implemented, human participation is required to produce examples of rules of interest. This allows the user to see the collection of files and select specific content and caller information to be included in alerts and reports.

The neural network then selects and filters counts of incoming calls with filtered counts of ‘good/target’ and ‘bad/not-target’ examples for each caller on the user's lists, Outgoing calls are analyzed based on specific rules as specified by the user for future search and discovery. This allows for the listing of ‘before’ and ‘after’ expressions (as they happened in voice exchange) for every chosen rule (i.e. was a certain topic discussed, was a voice mail delivered, etc.) A module for reporting about incoming, outgoing and stored voice files once the algorithm has been fully trained and is producing useful results is also implemented. It can be applied to any set of voice or text data. A fourth module is deployed for alerting about specified or target data.

A module for search and discovery of voice file content that works both like a keyword search engine, but unlike all other prior art also detects behavior patterns and contextual meaning. For example the application recognizes when the phrase “how much” is intended to equal “what is the cost”. In this way, the system is context-sensitive without relying entirely on keywords. The application is different than other neural network implementations for voice because it employs in general rules as well detection of unique instances of keyword combinations.

Content and Behavioral Analysis in IP and Next-Generation Networks Data Collection

Data collection is the first stage in implementing the invention's core technology. Application-level and Client usage records are input in order for the system to learn to differentiate between the target and non-target content and behaviors. In addition, the system has an interface with application-level usage records to describe the service provided to the customer, such as the billing records. These records will enable the user to determine the level of service and all the necessary details in regard to the service used. These billing records are typically collected from the servers providing the specific service, such as telephony services, video services, et cetera, and the Online Secretary design contains an implementation for a plug-in module that allows for billing reporting.

Application-level records are be provided by the following systems. In VoIP: media gateway controllers on the joint ITU and Internet Engineering Task Force (IETF) H.248 standard protocol, as well as the H.323 gatekeeper standard protocols. Application level records will also be provided in videoconferencing instances where broadcast and video servers are used, for music/video on demand, from voice switches as well as email servers and Web/WAP servers.

Login and Authentication Level

A typical NON, like standard LANs, include various login, authentication, authorization, and security mechanisms. These mechanisms are referred to as “login and authentication layer” provide vital information to the content analysis and filtering system. Information provided by the login and authentication will flow from the following elements. 1) Radius and LDAP servers; 2) remote access server (RAS); 3) DHCP and DNS servers; and, 4) Firewalls and VPN gateways.

A secondary element of the present invention contains a software module that interfaces with and analyzes network-level information. Network-level information describes the traffic and the flows at the IP layer. This layer typically characterizes bandwidth and resource consumption and its hardware configuration typically consists of routers and switches, SNMP/RMON I+II, Network Address Translation (NAT) and the access level commonly known as the technology that connects the customer for the “last mile”, such as cables, wireless, DSL, and dialup. This layer holds the information about the user location. It is also aware of the hardware and Layer-2 addresses of the user terminal, such as IMSI, serial numbers, and MAC address. Statistics collected by the access network are typically not affected when circumventing with the IP layer and therefore prove to be very useful for detecting irregular events. The system contains a software module that collects and processes information from elements such as, RAS, CMTS, DSLM, Integrated multiservice access platform (IMAP), and LMDS/WLL base stations.

Triggered Content Events

Triggered content events are defined in the training process of the neural network of the present invention. This will allow it to output a probability “x” that the packet or complete message contains, for example malicious scripts or urgent messages from an important client. At the network-level, it will recommend that a particular payload carried over the network be probed and searched for the text of known “exploit” scripts (used for hacking). Such activity is called packet spoofing, and the system will include a recommendation module for whether or not a message, set of messages, of messages from particular users should be quarantined for deep packet inspection and/or if standard packet-sniffing software should be utilized.

Triggered content events are being used today for intrusion detection systems but can also be useful for detecting elusive fraud scams. Voice recognition modules are included in the design of the present invention for situations where users and administrators wish to extract information and analyze patterns in the content of the messages themselves.

Neural Network

The neural network of the present invention has been engineered with non-negative matrix factorization (NMF), so that the firing rates of neurons are never negative, and the synaptic strengths do not change sign. The NMF step is performed prior to analysis of the data by the neural network. The non-negativity of the neurons and their weights corresponds to the physiological fact the firing rates of real biological neurons cannot be negative. By virtue of our implementation of these rules, the neural network embodies an additive, parts-based representation of the inputs. This provides a context through which to view the data represented in the input matrices, and allows the identification of discrete data which represent specific parts of the input. As a result, with the neural network of the present invention, we have an understanding of how the internal elements of the network are transforming the inputs to the outputs, and we can manipulate them appropriately. They are now data-rich and theory-rich They have the same applications as before, except they can be can “pre-loaded” with known facts about input-output relationships. Interestingly, other than the output “result” of the network itself, examining the internal elements is also a new kind of “result”, because it reveals the nature of the relationships of the inputs and the inputs to the output. Furthermore, this approach allows any new relationships that are revealed as the networks start to yield results right to be fed back into the network further improving its performance.

The data set consists of an n×m data set V, each one of the m columns of which contains n non-negative values of data. We would like t construct an approximate factorization of the form V≈WH, or

$${V}_{i μ} \approx {( WH )}_{i μ} = {\sum }_{σ = 1}^{r} {W}_{in} {H}_{σμ}$$

The r columns of W are the bases, and each column of H is called an encoding and is in one-to-one correspondence with a data column in V. An encoding consists of the coefficients by which a data column is represented with a linear combination of bases. The dimensions of the matrix factors W and H are n×r and r×m, respectively. The rank r of the factorization is generally chosen so that (n+m)r<nm, and the product WH can be regarded as a compressed form of the data in V [1].

Non-negative matrix factorization (NMF) does not allow negative entries in the matrices W and H. Only addictive combinations are allowed, because the non-zero elements of W and H are all positive. The non-negativity constraints are compatible with the intuitive notion of combining parts to form a whole.

One of the most useful properties of NMF is that it usually produces a sparse representation of the data. Such a representation encodes much of the data using few ‘active’ components, which makes the encoding easy to interpret. Sparse coding [2] has also been shown to be a useful middle ground between completely distributed representations on the one hand, and unary representations (grandmother cells) on the other [3].

However, the sparseness produced by NMF is a side-effect of the process, and not produced by design: one cannot control the degree to which the representation is sparse. In many applications, mote direct control over the properties of the representation is needed. Here we propose methods to control the sparseness of the factorized matrices.

To find an approximate factorization V≈WH, we first need to define a cost function that defines the quality of the approximation. The most straightforward cost function is simply the square of the Euclidian distance between the two terms:

$${‖ V - WH ‖}^{2} = {\sum }_{ij}^{} {( {V}_{ij} - {( WH )}_{ij} )}^{2}$$

Another useful term is the divergence between the two terms, defined as:

$$D ( V \vert \vert WH ) = {\sum }_{ij}^{} ( {V}_{ij} log \frac{{V}_{ij}}{{( WH )}_{ij}} - {V}_{ij} + {( WH )}_{ij} )$$

like the euclidian distance, this terms is also lower bounded by zero, and vanishes it and only if V=WH. Our task then becomes to minimize ∥V−WH∥² with respect to W and H, subject to the constraint that W, H≧0.

We use the following multiplicative algorithm [1] to factorize V:

$${W}_{ia} ← {W}_{ia} {\sum }_{μ}^{} \frac{{V}_{i μ}}{{( WH )}_{i μ}} {H}_{c μ}$$

$${W}_{ia} ← \frac{{W}_{ia}}{{\sum }_{j}^{} {W}_{ja}}$$

$${H}_{a μ} ← {H}_{a μ} {\sum }_{j}^{} {W}_{ia} \frac{{V}_{i μ}}{{( WH )}_{i μ}}$$

For measuring sparseness, we use a measure based on the relationship between the L1 and L2 norms:

$$sparseness ( x ) = \frac{\sqrt{n} - ( \sum \vert {x}_{i} \vert ) / \sqrt{\sum {x}_{i}^{2}}}{\sqrt{n} - 1}$$

where n is the dimensionality of x.

To adapt the NMF algorithm for sparseness, we contrain the sparseness at the end of every iteration in the following way:
sparseness(wᵢ)=S_{w}, ∀ᵢ
sparseness(hᵢ)=Sₕ, ∀ᵢ
   where w₁ is the ith column of W and hᵢ is the ith column of H. S_{w} and Sₕ are the desired sparseness of W and H respectively, and are set at the beginning.
   Pattern Recognition and Content Analysis Algorithms for IPT/NGNs

A set of algorithms has been developed that analyze content and behavioral patterns in VoIP and IPT exchanges. They are a combination of algorithmic approaches in the field of data mining, artificial intelligence, and machine learning. The Online Secretary expands existing detection methods through the introduction of new algorithms in order to ensure the detection of content and recognition of patterns. The design and engineering will allow it detect current fraud techniques, unsolicited communications or important content but of new and emerging patterns of threats and/or message senders.

We claim:

1. A system for the analysis of IP packets comprising
a. a data gathering module, for gathering input data consisting of a plurality of IP packets comprising an IP communications
b. a factoring module for performing non-negative matrix factorization on said input data;
c. a neural network module for analyzing the content of said factorized input data, based upon historical, learned preferences, to identify instances of said preferences in said input data; and
d. a reporting module for providing reports regarding the results of said analysis of said content and for providing alerts when said preferences are identified.
